(19) United States
(12) Patent Application Publication
(10) Pub. No.: US 2026/0206992 A1
(43) Pub. Date: Jul. 23, 2026

(54) Smart Mailbox System and Method

(71) Applicant: Wilson LOPES DE ARAUJO, Long Branch, NJ (US)

(72) Inventor: Wilson LOPES DE ARAUJO, Long Branch, NJ (US)

(21) Appl. No.: 19/034,112

(22) Filed: Jan. 22, 2025

(51) Int. Cl. A47G 29/124; A47G 29/122; G08B 29/02

(52) U.S. Cl. CPC A47G 29/124; A47G 29/1225; G08B 29/02; A47G 2029/1257

(57) ABSTRACT

Methods and apparatus for package and/or mail delivery. In some embodiments, a mailbox includes a housing defining one or more internal storage compartments; one or more lockable doors configured to provide access to the one or more internal storage compartments; one or more actuators configured to open and close the one or more doors and to lock and unlock the one or more doors; one or more sensors configured to detect delivery of a package or mail in the one of the one or more internal storage compartments; and a communication device coupled to the one or more sensors, the communication device configured to send a message to a user upon detection of delivery of the package or mail.

### FIELD

Embodiments of the present disclosure generally relate to a mailbox, and more particularly, to a smart mailbox.

### BACKGROUND

Typical mailboxes have a fixed size that may be used to receive letters and some packages. When packages are delivered that are larger than the mailbox, the delivery company may not deliver the package or leave the package outside of the mailbox or at another location near a residence or delivery address in plain sight. If the package is not delivered, the recipient will be inconvenienced. If the package is left visible, it becomes a target for theft. Also, typical mailboxes often are unlocked to permit postal employees to deliver mail and packages. This also leaves the contents of the mailbox vulnerable to theft.

Moreover, while hand delivery of packages continues, the use of automated package deliveries by land vehicles and aerial drones is being tested for various goods, such as food and drugs. However, the above-noted features of typical mailboxes do not facilitate use of automated land deliveries and aerial drone delivery.

Therefore, a mailbox is proposed that offers flexibility for various sized packages and allows for secure deliveries whether by human or automated delivery.

### SUMMARY

Methods and apparatus for package and/or mail delivery are provided herein. In some embodiments, a mailbox includes: a housing defining one or more internal storage compartments; one or more lockable doors configured to provide access to the one or more internal storage compartments; one or more actuators configured to open and close the one or more doors and to lock and unlock the one or more doors; one or more sensors configured to detect delivery of a package or mail in the one of the one or more internal storage compartments; and a communication device coupled to the one or more sensors, the communication device configured to send a message to a user upon detection of delivery of the package or mail.

In some embodiments, a method of operating a mailbox includes: authenticating delivery of a package or mail to a mailbox, the mailbox including a housing defining one or more internal storage compartments and one or more lockable doors configured to provide access to the one or more internal storage compartments; opening the door of the mailbox when the delivery is authenticated; receiving the package or mail into at least one of the one or more internal storage compartments and detecting the presence of the package or mail in the internal storage compartment; securely closing the one or more doors of the mailbox upon detecting the presence of the package or mail; and sending a message to a user upon detection of delivery of the package or mail.

Other and further embodiments of the present disclosure are described below.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

FIG. 1A shows a smart mailbox in accordance with some embodiments of the present disclosure.

FIG. 1B shows a side elevation view of the smart mailbox of FIG. 1A.

FIG. 2 shows a smart mailbox in accordance with another embodiment of the present disclosure.

FIG. 3 shows a smart mailbox in accordance with another embodiment of the present disclosure.

FIG. 4 shows a method in accordance with some embodiments of the present disclosure.

FIG. 5 shows a high-level block diagram of an embodiment of the mailbox in accordance with some embodiments of the present disclosure.

FIG. 6 depicts a high-level block diagram of an embodiment of a network architecture of a system for operating a mailbox in accordance with the present principles.

FIG. 7 depicts a high-level block diagram of a computing device suitable for use with embodiments for operating a mailbox in accordance with the present principles.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

Embodiments of methods and apparatus for package and mail delivery are provided herein. In some embodiments, the apparatus includes a mailbox, which is a smart, automated mailbox that facilitates, organizes, and protects the receipt of packages and mail, to meet the demands of traditional mail and package delivery and modern mail and package delivery, including automated vehicle deliver (e.g., drone delivery). The mailbox in accordance with some embodiments, may integrate connectivity, automation, sustainable energy, and reinforced security to change the way deliveries are received in comparison to traditional package and mail delivery.

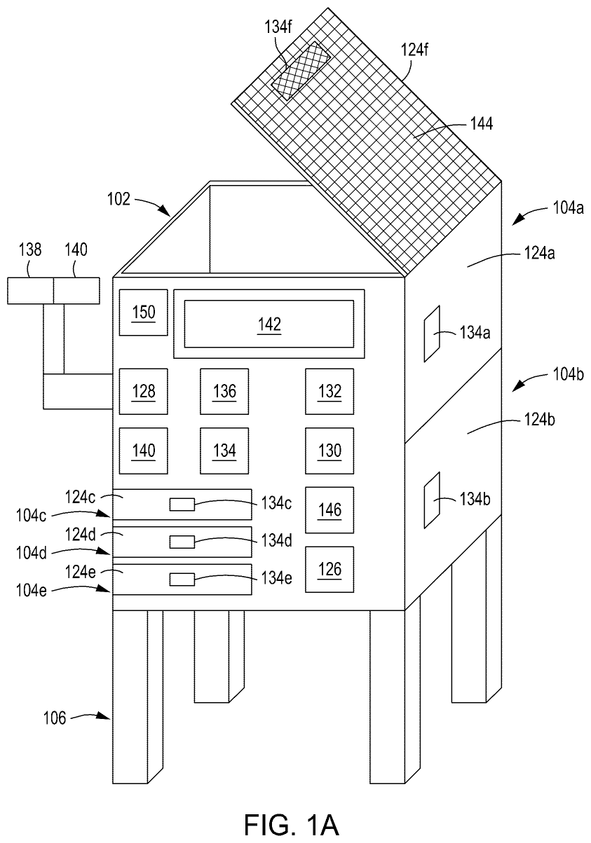

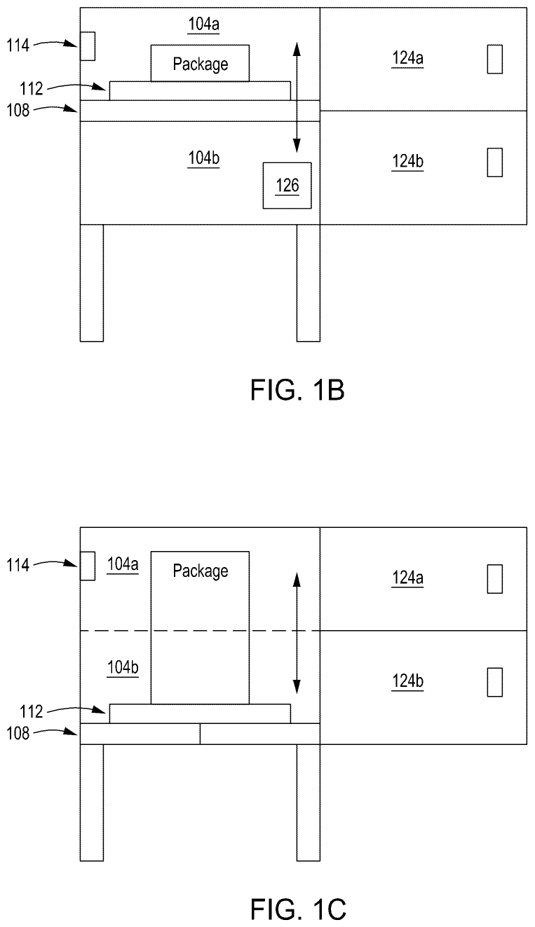

FIG. 1A shows a mailbox 100 in accordance with some embodiments of the present disclosure. The mailbox 100 includes a housing 102, which defines one or more internal storage compartments 104a-104e for storing packages and mail. Unless specifically mentioned otherwise, “package” and “mail” are used interchangeably throughout.

The housing 102 may be supported by optional legs 106. In some embodiments, and described in greater detail below, at least one of the one or more internal storage compartments 104a-104e are dynamically adjustable in size, such as with an elevator, based on user needs and/or sizes of packages or mail. In some embodiments, the dimensions of the one or more internal storage compartments 104a-104e may be from 5 inches to 65 inches. In some embodiments, the housing 102 may be made from a metal, such as aircraft-grade aluminum, and may be corrosion-resistant, lightweight and durable, with UV coating for longer service life in outdoor environments.

In some embodiments, the one or more internal storage compartments 104a-104e may include at least one large compartment 104a-104b and a plurality of relatively smaller compartments 104c-104e. In some embodiments, the one or more internal storage compartments 104a-104e may include four large compartments for large boxes (e.g., packages or meals) and six smaller compartments for envelopes and letters. In some embodiments, each of the compartments 104a-104e are separately accessible and lockable.

In some embodiments, an as shown in FIG. 1B, the mailbox 100 may include an internal modular system that includes one or more elevator platforms 108 that are configured to dynamically adjust the size of one or more internal storage compartments 104a-104e to organize deliveries according to the size of the packages or envelopes. The one or more elevator platforms 108 may be raised and lowered by electric motor. The one or more elevator platforms 108 may ride on rails or a track.

The internal modular system may include one or more sensors configured to detect delivery of a package in one of the one or more internal storage compartments 104a-104e. In some embodiments, and as shown in FIG. 1B, the one or more sensors may include a weight sensor 112 to measure the weight of the package or mail or a volume sensor 114 sensor to measure the volume of the package or mail. In some embodiments, weight sensor 112 may include an integrated electronic scale. In some embodiments, the volume sensor 114 may include one or more sensors to calculate dimensions, such as ultrasonic sensors or infrared light sensors, which can measure the volume of objects by detecting their height, width, and depth. In some embodiments, the one or more elevator platforms 108 may be raised or lowered into positions corresponding substantially to the bottom of one or more compartments 104a-104b. For example, as shown in FIG. 1C, the package (e.g., box) is too tall to fit in the upper compartment 104a. Thus, the elevator 108 is shown in FIG. 1C lowered to the bottom of the lower compartment 104b to allow the package to fit in the housing 102 using substantially the combined space of compartments 104a and 104b.

As shown in FIG. 1, the mailbox 100 may include one or more lockable doors 124a-124f configured to provide access to the one or more internal storage compartments 104a-104e. In some embodiments, each door 124a-124e may correspond to one of the storage compartments 104a-104e. However, in instances where the elevator expands a storage compartment to combine storage compartments, as shown for example in FIG. 1C, multiple doors may be opened to access the package in the combined storage compartments.

As shown in FIG. 1A, the doors 124a-124e may be on sides of the mailbox 100 and the door 124f (otherwise referred to herein as a lid) may be on a top of the mailbox 100. In some embodiments, one or more of the doors 124a-124f may function as a landing pad for a drone and/or as an unloading platform for a package. For example, the door 124f may function as a landing pad in the closed position of the door 124f shown in FIG. 1A. In the embodiment shown in FIG. 1A, a drone may deposit packages or mail in internal storage compartments 104a-104b when the door 124f is open.

In some embodiments, a user (e.g., a resident of a home or residence to which the mailbox 100 is associated) of the mailbox 100 will receive a unique code that allows the user to open and close the doors 124a-124f. While the user may use the unique code to open the doors 124a-124f to pickup mail and/or packages left in the mailbox 100, the user may also use the unique code to open the doors 124a-124f to place mail and/or packages into the mailbox 100 for pickup from the mailbox by authorized delivery personnel or vehicles. In some embodiments, the mailbox 100 may be remotely accessed and controlled via a mobile app (e.g., using message notification module 624) accessible from the user device 602, which may leverage artificial intelligence for enhanced user convenience and security.

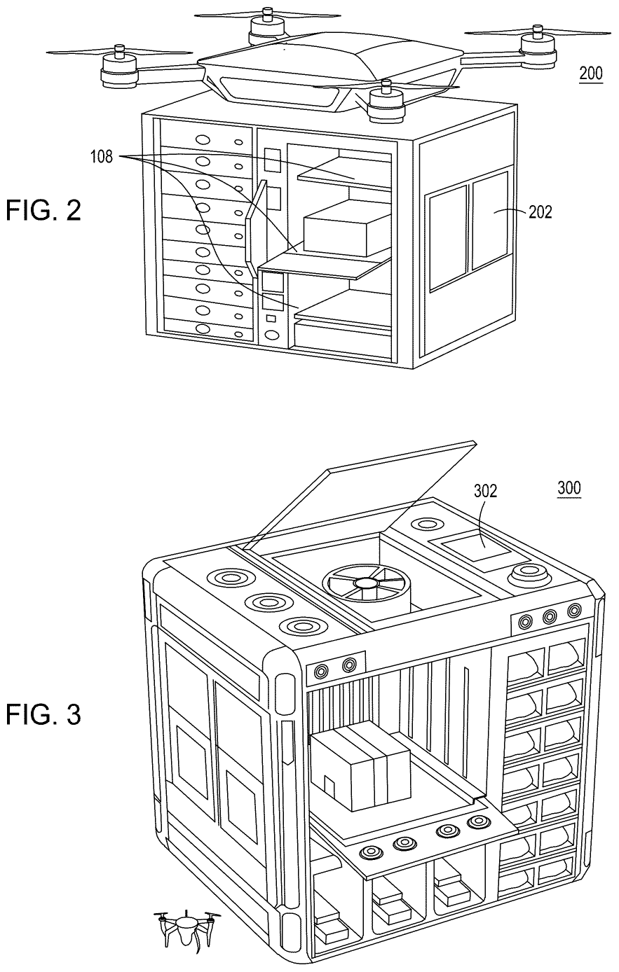

In some embodiments, one or more of the doors 124a-124f may open into a horizontal position to provide a landing pad for a drone. In some embodiments, and as shown in FIG. 2, one or more of the doors 124a-124e may be operatively coupled to one of the elevator platform 108, and the elevator platform may be configured to slide inward and outward with respect to the housing 102 to load and unload packages or mail from a drone. While drone delivery may be facilitated in some instances by delivery through the top of the housing 102 when the door 124f is open, this is not a requirement and it is envisioned that drone delivery may be accomplished from the sides of the housing 102.

The mailbox 100 may include one or more actuators 126 configured to open and close, as well as lock and unlock, each door 124a-124f. As discussed in greater detail below, in some embodiments, any of the doors 124a-124f may open in response to authenticating a delivery or pickup, such as by using proximity sensors and/or identification with QR code or barcode. In some embodiments, the doors 124a-124f may be configured to close and lock automatically after delivery or pickup of a package and/or mail to prevent tampering or theft.

In some embodiments, the mailbox 100 may include an authentication system configured to authenticate delivery and/or pickup of packages or mail and actuate the one or more actuators 126 to unlock and open one or more of the doors 124a-124f based upon the authentication. In some embodiments, the authentication system may include a scanner 127 configured to read a code (e.g., QR code or barcode) on at least one of the package or mail, delivery personnel, or delivery vehicle (e.g., drone) and cause unlocking and opening of one or more doors 124a-124f based on results of the scan. For example, if a delivery person scans a code (e.g., barcode or QR code) on an employee badge and the mailbox 100 determines that the delivery person is not authorized to make a delivery, the mailbox 100 will not open one or more doors 124a-124f. However, if the delivery person is authorized, the mailbox 100 will open the one or more doors 124a-124f to receive the package or mail.

Also, the mailbox 100 may include a communication device 128 configured to send a message to a user upon detection of delivery of a package. The communication device may be a wireless or wired communication device. For example, the communication device 128 may be a Bluetooth or wifi device or may include cellular telephony capabilities. The communication device may be configured for bi-directional communication with a user of the mailbox 100. The communication device 128 may be coupled to one or more of the weight sensor 112 and volume sensor 114 which may be used to detect delivery of a package. In some embodiments, the message may be a text message and/or email message. The message may include a name of a recipient of the package and/or mail and/or identification of the at least one internal storage compartment in which the package and/or mail is received. In some embodiments, the messages may be sent to a user mobile device (e.g., cell phone, tablet computer, laptop computer), although any form of electronic communication may be used to transmit and receive the message.

The mailbox 100 may include one or more additional features to enhance security of the mailbox 100 and prevent theft of packages or mail or of the mailbox itself. In some embodiments, the mailbox 100 may include a proximity sensor 130 to detect proximity and/or motion of objects around the mailbox 100 within a certain perimeter of the mailbox 100. In some embodiments, the communication device 128 may be coupled with the proximity sensor 130 and configured to send a message to a user if objects are detected within a predefined perimeter of the mailbox 100. In some embodiments, the mailbox 100 may include a camera 132 configured for image and/or video capture around the mailbox 100. The camera 132 may be coupled with the communication device 128 and the proximity sensor 130 to send images or video captured by the camera 132 either on demand by the user or in response to a detection by the proximity sensor of motion near the mailbox 100. In some embodiments, multiple cameras 132 may be used, such as a front camera and a rear camera. The camera 132 may have night vision to record in low light environments. In some embodiments, the cameras 132 enable real-time monitoring with motion detection and local and/or cloud recording.

In some embodiments, the cameras 132 may be part of a security camera system of the mailbox 100 that allows real-time communication between delivery personnel and/or delivery vehicles and users, such as through telephone or video conferencing using the user device 602. In some embodiments, police or private security services may have access to one or more cameras 132. In some embodiments, the mailbox 100 may have one or more cameras 132 positioned to face frontward (i.e., facing the street) and to which municipal authorities (e.g., police) may have access, with or without requiring user authorization, using a unique access code assigned to the municipal authority. In some embodiments, the mailbox 100 may have one or more cameras 132 positioned to face rearward (i.e., facing a user residence) and to which access to this camera 132 is restricted and requires either user authorization or a court order.

In some embodiments, the mailbox 100 may include a tamper sensor 135 configured to detect tampering of the mailbox 100 and cause transmission of an alert. In some embodiments, the tamper sensor 135 may be configured to detect vibration and/or impacts to the mailbox 100 indicative of tampering with the mailbox 100. The tamper sensor 135 may be coupled with the camera 132 and the communication device 128 to cause transmission of a message that may include images or video obtained when triggered by the tamper sensor 135. In some embodiments, the mailbox 100 may include a siren 136 or other audio output device, which can be coupled with the tamper sensor 135. The siren 136 may be activated to generate an audible alert when the tamper sensor 135 detects tampering with the mailbox 100.

In some embodiments, the mailbox 100 may include a GPS beacon 138 (e.g., directional GPS) configured to emit a GPS beacon signal to guide delivery of the package and/or mail to the mailbox 100. The GPS beacon 138 may also be used to track the mailbox 100 if the mailbox 100 is stolen or otherwise physically moved from its designated location. In some embodiments, the mailbox 100 may include a light 140 or light panel 142 so that upon a package and/or mail reaching the destination at the mailbox 100, the light 140 or light panel 142 automatically lights up and may display an address or house number.

In some embodiments, the mailbox 100 may include a power source to power one or more powered components discussed above. In some embodiments, the power source may include at least one of a solar panel 144 or a battery 146. In some embodiments, one or more solar panels 144 may be on the top (e.g., on door 124f) or sides of the housing 102 of the mailbox 100 to provide sustainable energy and reduce electrical consumption. In some embodiments, the solar panels 144 may connect to the battery 146 for guaranteed continuous operation in case of power outages. In some embodiments, the power source may include a mains power source configured to provide continuous power to the mailbox and to charge the backup battery. In some embodiments, the various sensors, cameras, and components of the mailbox 100 may utilize low-power technology for increased sustainability.

In some embodiments, the mailbox 100 may include a controller 150 that is configured to control the various functions of the mailbox 100 described herein. FIG. 5 shows a high-level block diagram of the mailbox 100 in accordance with some embodiments of the present disclosure. As shown in FIG. 5, the controller 150 may be connected via a bus 502 to various components of the mailbox 100 described herein. The bus 502 may be wired or wireless.

FIG. 2 shows another mailbox 200 in accordance with some embodiments of the present disclosure. As shown in FIG. 2, the mailbox 200 may include multiple elevator platforms 108, which may be connected to doors as discussed above. In some embodiments, and as shown in FIG. 2, the housing 102 may include a window 202 to view contents inside the mailbox 200.

FIG. 3 shows another mailbox 300 in accordance with some embodiments of the present disclosure. As shown in FIG. 3, the mailbox 300 may have an electronic display panel 302 to display information about various functions of the mailbox 300 as well as the status of the storage compartments of the mailbox 300. In some embodiments, an authorized user of the mailbox 300 may be able to view information, including delivery notification messages, on the display panel 302. In some embodiments, an authorized user may input one or more settings of the mailbox 300 using the display panel 302.

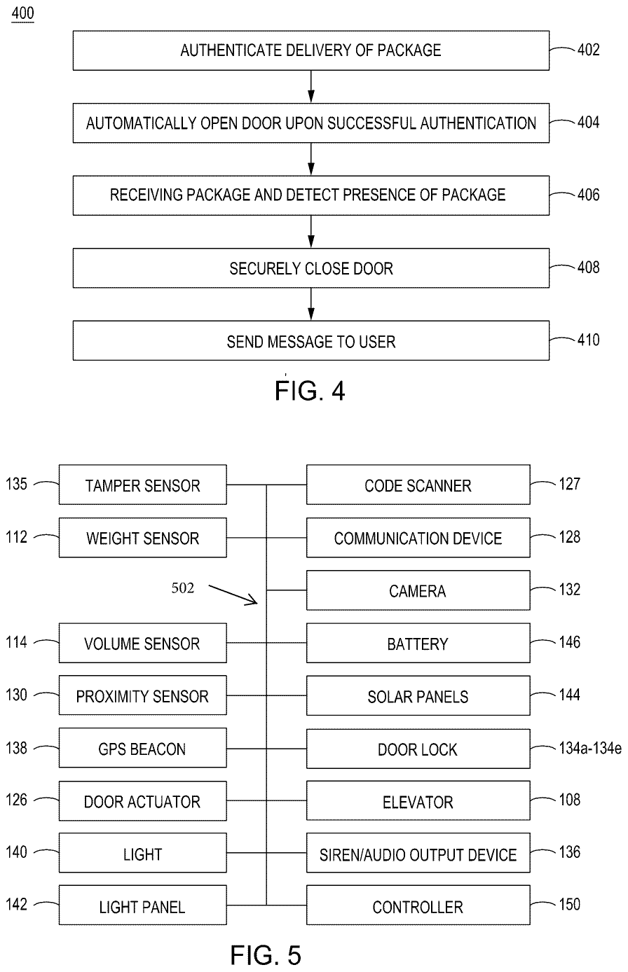

FIG. 4 shows a method 400 of using or otherwise operating a mailbox in accordance with some embodiments of the present disclosure. At block 402, the method 400 includes authenticating delivery of a package and/or mail at a mailbox such as mailboxes 100, 200, or 300 configured in accordance with the present disclosure. In some embodiments, authenticating includes using a scanner on the mailbox to scan a code on the package, mail, or delivery personnel or vehicle. For example, a drone delivering a package may have a code (barcode or QR code) which may be scanned by the scanner of the mailbox 100 and if the authentication is successful, the drone may be allowed permission to make delivery of the package to the mailbox 100.

At block 404, the method 400 may include automatically opening the one or more doors of the mailbox upon authentication of delivery of the package and/or mail. As described above, one or more actuators 126 may be provided to unlock and open the one or more of doors 124a-124f of the mailbox 100. At block 406, the method 400 may include receiving the package and/or mail into one or more of the one or more internal storage compartments and detecting the presence of the package and/or mail in the one or more internal storage compartments. In some embodiments, receiving the package and/or mail may include resizing or otherwise adjusting the one or more internal storage compartments 104a-104e of the mailbox 100 to accommodate the identified package and/or mail. As described herein, in some embodiments, one or more of the internal storage compartments 104a-104e may be resized by adjusting one or more elevator platforms 108.

In some embodiments, even if delivery is authenticated, the unlocking and opening of the one of the doors 124a-124f may be prevented if there is insufficient space inside the mailbox 100 (i.e., if the mailbox is full). In such instances, the doors 124a-124f may remain closed and locked and delivery will be refused.

In some embodiments, the mailbox 100 provides direct communication with the user, such as through user device 602, enabling the user to provide instructions on alternative delivery arrangements if a package and/or mail is too large to fit in the mailbox 100. In some embodiments, the mailbox 100 may promote the use of standardized envelopes and boxes, which may be made available at post offices, retail stores, and distribution or fulfillment centers, ensuring compatibility with the mailbox 100.

At block 408, the method 400 includes securely closing the door of the mailbox upon detecting the presence of the package or mail. For example, one or more of the doors 124a-124f of mailbox 100 may be closed and locked by the one or more actuators 126.

At block 410, the method includes sending a message to a user upon detection of delivery of the package and/or mail. The message may include a name of a recipient of the package or mail and/or identification of the one or more internal storage compartments in which the package and/or mail is received. If delivery is refused, as discussed above, the message may include a notification including the delivery company and scanned code, which may be used by the user of the mailbox 100 to track the mail and/or package and arrange alternate delivery arrangements.

In some embodiments, the method 400 may includes emitting a GPS locator beacon signal to guide delivery of the package and/or mail to the mailbox. For example, the GPS beacon 138 may be used for emitting a GPS locator beacon. In some embodiments, the method 400 may include illuminating at least a portion of the mailbox when the package and/or mail is within a predefined distance of the mailbox. In some embodiments, when a vehicle or delivery person approaches the mailbox, the light 140 or light panel 142 may light up and may display the postal address number associated with the mailbox 100.

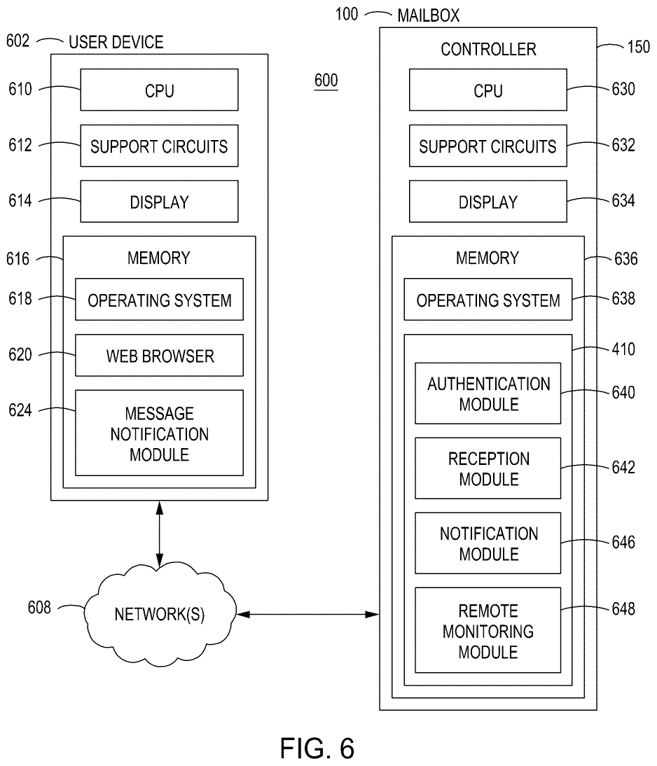

FIG. 6 depicts a block diagram of a system 600 in accordance with at least one embodiment of the disclosure. The system 600 includes one or more user devices 602, and a mailbox 100 communicatively coupled via one or more networks 608.

The networks 608 comprise one or more communication systems that connect computers by wire, cable, fiber optic and/or wireless link facilitated by various types of well-known network elements, such as hubs, switches, routers, and the like. The networks 606 may include an Internet Protocol (IP) network, a public switched telephone network (PSTN), or other mobile communication networks, and may employ various well-known protocols to communicate information amongst the network resources.

The end-user device (also referred throughout as “user device”) 602 comprises a Central Processing Unit (CPU) 610, support circuits 612, display device 614, and memory 616. The CPU 610 may comprise one or more commercially available microprocessors or microcontrollers that facilitate data processing and storage. The various support circuits 612 facilitate the operation of the CPU 610 and include one or more clock circuits, power supplies, cache, input/output circuits, and the like. The memory 616 comprises at least one of Read Only Memory (ROM), Random Access Memory (RAM), disk drive storage, optical storage, removable storage and/or the like. In some embodiments, the memory 616 comprises an operating system 618, web browser 620, and message notification module 624.

The operating system (OS) 618 generally manages various computer resources (e.g., network resources, file processors, and/or the like). The operating system 618 is configured to execute operations on one or more hardware and/or software modules, such as Network Interface Cards (NICs), hard disks, virtualization layers, firewalls and/or the like. Examples of the operating system 618 may include, but are not limited to, various versions of LINUX, MAC OSX, BSD, UNIX, MICROSOFT WINDOWS, IOS, ANDROID and the like.

The web browser 620 is a well know application for accessing and displaying web page content. Such browsers include, but are not limited to, Safari®, Chrome®, Explorer®, Firefox®, etc.

In some embodiments, the message notification module 624 is a message application service that runs on the user device 602 in the background. In embodiments, the message notification module 624 may store and display messages received from the mailbox 100 concerning various events, such as delivery of packages and/or mail, tampering with the mailbox 100, proximity sensor messages, or messages with images or video around the mailbox 100. In some embodiments, the web browser 620 may be used to interact with the mailbox 100. For example, a user may send a request to the mailbox 100 to view camera images or video, check on the status of power levels of solar panels 144 or battery 146, as well as check on the status of packages or mail in the mailbox 100.

In some embodiments, the user device 602 may include third-party applications running in the background. For example, the user device 602 may have stored in memory 616 virtual assistant applications such as ALEXA and GOOGLE ASSISTANT, which may be configured to receive notifications from notification module 646.

In some embodiments, the controller 150 of the mailbox 100 may comprise a Central Processing Unit (CPU) 630, support circuits 632, a display device 634 (like display 302), and memory 636. The CPU 630 may comprise one or more commercially available microprocessors or microcontrollers that facilitate data processing and storage. The various support circuits 632 facilitate the operation of the CPU 630 and include one or more clock circuits, power supplies, cache, input/output circuits, and the like. The memory 636 comprises at least one of Read Only Memory (ROM), Random Access Memory (RAM), disk drive storage, optical storage, removable storage and/or the like. In some embodiments, the memory 636 comprises an operating system 638, an authentication module 640, and a notification module 642, a reception module 642, a notification module 646, and a remote monitoring module 648.

The authentication module 640 is configured to authenticate package delivery for the mailbox 100. In embodiments, the authentication module 640 may operate the scanner 127 to scan a code (e.g., barcode or QR code) on a package or delivery vehicle or personnel to authenticate the delivery. If delivery is not authenticated, the controller 150 will not allow any of the doors 124a-124f of the mailbox to be opened.

The reception module 642 may be used to control actuation of one or more doors 124a-124f and locks 134a-134f of the mailbox 100 as well as control movement of one or more elevator platforms 108 to organize space inside the mailbox 100. In some embodiments, the reception module 642 may control the one or more actuators 126 and door locks 134a-134f to unlock and open one or more of the doors 124a-124f when the delivery is authenticated. In embodiments, even if delivery is authenticated, the reception module 642 may prevent unlocking and opening of the one of the doors 124a-124f if there is insufficient space inside the mailbox 100 (i.e., if the mailbox is full). The reception module 642 also may control the actuation of the one or more doors 124a-124f and locks 134a-134f of the mailbox 100 to close all of the doors 124a-124f and locks 134a-134f after delivery is completed.

In some embodiments, the reception module 642 may receive inputs from at least one of a weight sensor 112 or volume sensor 114 to identify available space and to calculate a size of a respective storage compartment to house a package or mail. In embodiments, the reception module 642 may control one or more elevator platforms 108 to increase or decrease the size of a compartment to accommodate a package or mail.

The notification module 646 may send messages to the user device 602, which may be processed by the message notification module 624. In some embodiments, the reception module 642 may send a signal to the notification module 646 upon completion and detection of a delivery in one or more internal storage compartments 104a-104e of the mailbox 100. The signal from the reception module 642 may include at least one of a delivery time stamp, package or mail size, package or mail weight, and internal storage compartment designation. The notification module 646 may transmit a message that includes at least one of a delivery time stamp, package or mail size, package or mail weight, and internal storage compartment designation to the user device 602, where it may be viewed by a user.

Also, as described further, the notification module 646 may receive signals from the remote monitoring module 648 and generate messages for transmission to the message notification module 624.

The remote monitoring module 648 may function as a background process for supplementing security for the mailbox 100. In embodiments, the remote monitoring module 648 may receive input from the tamper sensor 135. In embodiments where the tamper sensor 135 senses vibration that exceeds a threshold indicative of tampering, the remote monitoring module 648 may trigger an alarm and send a signal to the notification module 646. The notification module may receive the tampering signal and, in-turn, generate and send a tampering message to the message notification module 624. The tampering message may include a time stamp. Also, the remote monitoring module may activate the camera 132 to acquire images or video of surroundings of the mailbox 100 which can be stored and transmitted with the tampering message or retrieved by the user separately using the web browser 620, for example.

In some embodiments, the remote monitoring module 648 may receive input from the proximity sensor 130 to determine distance of unauthorized vehicles or personnel and send a proximity alarm to the notification module 646. The notification module 646 may process the proximity alarm and generate and send a message to the message notification module 624 to alert a user of a potential security threat. The remote monitoring module 648 may also activate the camera 132 to capture images or video when the proximity alarm is triggered.

In some embodiments, the remote monitoring module 648 monitors deviation between a designated GPS location of the mailbox 100 and its current location to determine whether the mailbox 100 has been moved or stolen. In embodiments, when the deviation exceeds a threshold, the remote monitoring module 648 may trigger a tampering alarm as described above.

The remote monitoring module 648 may also control operation of the siren 136 to deter theft. In cases where the tampering alarm has been triggered, the remote monitoring module 648 may activate the siren 136.

The remote monitoring module 648 may also monitor the status of the solar panels 144 and the battery 146. In embodiments, if the power output of the solar panels 144 and the battery 146 are insufficient to power the mailbox 100, the remote monitoring module 648 may generate a power alarm. The notification module 646 may generate and send a power message to the message notification module 624 to notify the user of the insufficient power status of the mailbox 100. The power message may include at least one of a time stamp, an output voltage level of the solar panels 144 and battery 146, or a status indicator (e.g., good or bad) of the solar panels 144 and battery 146.

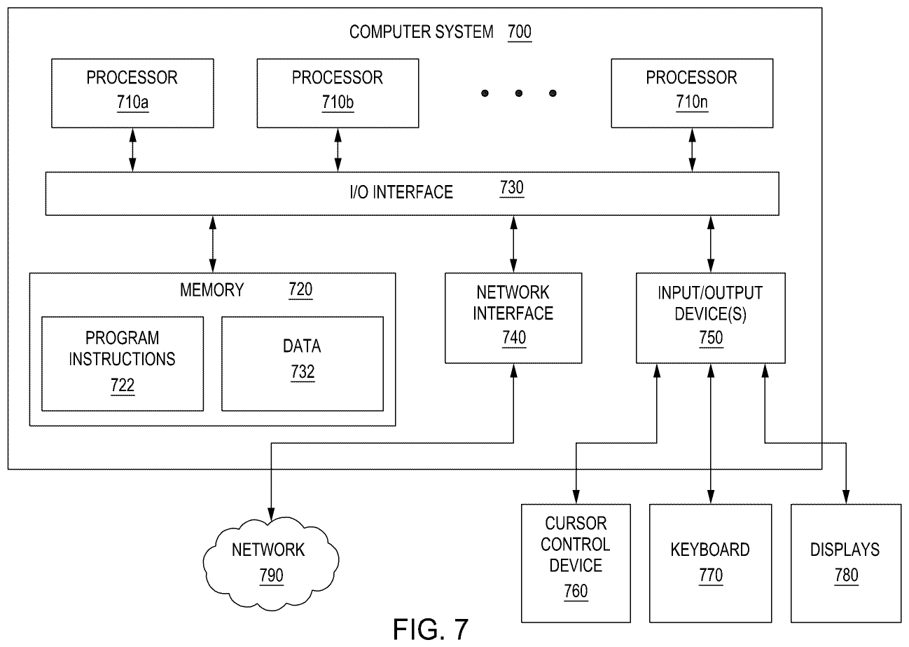

FIG. 7 depicts a computer system 700 that can be utilized in various embodiments of the invention to implement the computer and/or the display, according to one or more embodiments.

Various embodiments of method and system for a mailbox, as described herein, may be executed on one or more computer systems, which may interact with various other devices. One such computer system is computer system 700 illustrated by FIG. 7, which may in various embodiments implement any of the elements or functionality illustrated in FIGS. 1-6. In various embodiments, computer system 700 may be configured to implement methods described above. The computer system 700 may be used to implement any other system, device, element, functionality or method of the above-described embodiments. In the illustrated embodiments, computer system 700 may be configured to implement the method 400 as processor-executable executable program instructions 722 (e.g., program instructions executable by processor(s) 710) in various embodiments.

In the illustrated embodiment, computer system 700 includes one or more processors 710a-710n coupled to a system memory 720 via an input/output (I/O) interface 730. Computer system 700 further includes a network interface 740 coupled to I/O interface 730, and one or more input/output devices 750, such as cursor control device 760, keyboard 770, and display(s) 780. In various embodiments, any of the components may be utilized by the system to receive user input described above. In various embodiments, a user interface may be generated and displayed on display 780. In some cases, it is contemplated that embodiments may be implemented using a single instance of computer system 700, while in other embodiments multiple such systems, or multiple nodes making up computer system 700, may be configured to host different portions or instances of various embodiments. For example, in one embodiment some elements may be implemented via one or more nodes of computer system 700 that are distinct from those nodes implementing other elements. In another example, multiple nodes may implement computer system 700 in a distributed manner.

In different embodiments, computer system 700 may be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments processors 710 may be general-purpose or embedded processors implementing any of a variety of instruction set architectures (ISAs). In multiprocessor systems, each of processors 710 may commonly, but not necessarily, implement the same ISA.

System memory 720 may be configured to store program instructions 722 and/or data 732 accessible by processor 710. In various embodiments, system memory 720 may be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 720. In other embodiments, program instructions and/or data may be received, sent or stored upon different types of computer-accessible media or on similar media separate from system memory 720 or computer system 700.

In one embodiment, I/O interface 730 may be configured to coordinate I/O traffic between processor 710, system memory 720, and any peripheral devices in the device, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. Also, in some embodiments some or all of the functionality of I/O interface 730, such as an interface to system memory 720, may be incorporated directly into processor 710.

Network interface 740 may be configured to allow data to be exchanged between computer system 700 and other devices attached to a network (e.g., network 790), such as one or more external systems or between nodes of computer system 700. In various embodiments, network 790 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 740 may support communication via wired or wireless general data networks, such as any suitable type of Ethernet network, for example; via digital fiber communications networks; via storage area networks such as Fiber Channel SANs, or via any other suitable type of network and/or protocol.

Input/output devices 750 may, in some embodiments, include one or more display terminals, keyboards, keypads, touchpads, scanning devices, voice or optical recognition devices, or any other devices suitable for entering or accessing data by one or more computer systems 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

In some embodiments, the illustrated computer system may implement any of the operations and methods described above, such as the methods illustrated by the flowchart of FIG. 4. In other embodiments, different elements and data may be included.

Those skilled in the art will appreciate that computer system 700 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media, which may be read and executed by one or more processors. A machine-readable medium may include any mechanism for storing or transmitting information in a form readable by a machine (e.g., a computing device or a “virtual machine” running on one or more computing devices). For example, a machine-readable medium may include any suitable form of volatile or non-volatile memory.

Modules, data structures, and the like defined herein are defined as such for ease of discussion and are not intended to imply that any specific implementation details are required. For example, any of the described modules and/or data structures may be combined or divided into sub-modules, sub-processes or other units of computer code or data as may be required by a particular design or implementation.

In the drawings, specific arrangements or orderings of schematic elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application-programming interface (API), and/or other software development tools or frameworks. Similarly, schematic elements used to represent data or information may be implemented using any suitable electronic arrangement or data structure. Further, some connections, relationships or associations between elements may be simplified or not shown in the drawings so as not to obscure the disclosure.

While the foregoing is directed to embodiments of the present disclosure, other and further embodiments of the disclosure may be devised without departing from the basic scope thereof.

1. A mailbox comprising:
a housing defining one or more internal storage compartments;
one or more lockable doors configured to provide access to the one or more internal storage compartments;
one or more actuators configured to open and close the one or more doors and to lock and unlock the one or more doors;
one or more sensors configured to detect delivery of a package or mail in the one of the one or more internal storage compartments; and
a communication device coupled to the one or more sensors, the communication device configured to send a message to a user upon detection of delivery of the package or mail,
wherein the one or more sensors includes a volume sensor configured to sense the volume of the package or mail.

2. The mailbox of claim 1, wherein the one or more internal storage compartments includes at least one compartment having dimensions that are dynamically adjustable based on the detected volume of the package.

3. The mailbox of claim 1, wherein the one or more internal storage compartments include one large compartment and a plurality of relatively smaller compartments.

4. The mailbox of claim 3, wherein each of the plurality of smaller compartments are separately accessible and lockable.

5. The mailbox of claim 1, further comprising an authentication system configured to authenticate delivery of the package or mail and actuate the one or more actuators to open and close the one or more doors based upon the authentication.

6. The mailbox of claim 5, wherein the authentication system includes a scanner configured to read a code on at least one of the package or mail, delivery vehicle, or delivery personnel, and cause actuation of the one or more doors based on results of the scan.

7. The mailbox of claim 1, further comprising at least one of:
a proximity sensor to detect proximity and/or motion of objects within a certain perimeter of the mailbox,
a camera configured to capture images or video of an area surrounding the mailbox, or
a tamper sensor configured to detect tampering of the mailbox.

8. The mailbox of claim 1, wherein the one or more sensors includes a weight sensor configured to sense weight of the package or mail.

9. The mailbox of claim 1, further comprising a GPS beacon configured to emit a GPS beacon signal for guiding delivery of the package or mail to the mailbox.

10. The mailbox of claim 1, wherein the one or more doors includes at least one door on a top or side of the housing.

11. The mailbox of claim 1, further comprising an electrical power source to power at least one of the one or more actuators, the one or more sensors, or the communication device.

12. The mailbox of claim 11, wherein the electrical power source includes at least one of a solar panel or a battery.

13. The mailbox of claim 1, wherein at least one of a top of the housing or the one or more lockable doors includes a landing pad for a drone.

14. A method of operating a mailbox, the method comprising:
authenticating delivery of a package or mail to a mailbox, the mailbox including a housing defining one or more internal storage compartments and one or more lockable doors configured to provide access to the one or more internal storage compartments;
opening the door of the mailbox when the delivery is authenticated;
receiving the package or mail into at least one of the one or more internal storage compartments and detecting the presence of the package or mail in the internal storage compartment;
sensing the volume of the package or mail;
securely closing the one or more doors of the mailbox upon detecting the presence of the package or mail; and
sending a message to a user upon detection of delivery of the package or mail.

15. The method of claim 14, wherein the one or more internal storage compartments include one large compartment and a plurality of relatively smaller compartments.

16. The method of claim 15, wherein each of the plurality of smaller compartments are separately accessible and lockable.

17. The method of claim 14, wherein authenticating the delivery includes using a scanner on the mailbox to scan a code on at least one of the package or mail, a delivery vehicle, or delivery personnel.

18. The method of claim 14, further comprising adjusting the one or more internal storage compartments based on the sensed volume of the package or mail to accommodate the package or mail.

19. The method of claim 14, wherein the message includes a name of a recipient of the package or mail and/or identification of the one or more internal storage compartments in which the package or mail is received.

20. The method of claim 14, further comprising emitting a GPS locator beacon to guide delivery of the package or mail to the mailbox; and illuminating at least a portion of the mailbox when the package or mail is within a predefined distance of the mailbox.
